(19) United States
(12) Patent Application Publication
(10) Pub. No.: US 2013/0211868 A1
(43) Pub. Date: Aug. 15, 2013

(54) Indication of Partial Meeting Request Responses

(71) Applicant: Lisa Seacat DeLuca, San Francisco, CA (US)

(72) Inventor: Lisa Seacat DeLuca, San Francisco, CA (US)

(73) Assignee: International Business Machines Corporation, Armonk, NY (US)

(21) Appl. No.: 13/397,512

(22) Filed: Feb. 15, 2012

(51) Int. Cl. G06Q 10/10

(52) U.S. Cl. 705/7.19

(57) ABSTRACT

An embodiment of the invention provides a method for indicating partial meeting request responses, wherein a digital meeting invitation is sent from a processor to an electronic messaging device of an invitee. The meeting invitation includes a time period of the meeting, a meeting declination option, a meeting acceptance option, a partial meeting declination option, and a partial meeting acceptance option. A digital response is received from the invitee, wherein the response includes a partial meeting declination selection and/or a partial meeting acceptance selection. The partial meeting declination selection includes at least one time slot during the time period of the meeting that the invitee will not attend. The partial meeting acceptance selection includes at least one time slot during the time period of the meeting that the invitee will attend. In another embodiment, the response includes a meeting declination selection or a meeting acceptance selection.

### BACKGROUND

The present invention is in the field of methods, systems, and computer program products for indicating partial meeting request responses.

Meetings are a staple of enterprise operations. Such meetings may be teleconferences (e.g., a web conferences, video conferences, phone calls, etc.) or face-to-face meetings in conference rooms, auditoriums, etc. An organizer of a meeting (also referred to herein as a “moderator”) can propose a topic, time, date and location for the meeting in invitations that are sent to potential attendees.

### SUMMARY OF THE INVENTION

An embodiment of the invention provides a method for indicating partial meeting request responses, wherein a digital meeting invitation is sent from a processor to an electronic messaging device of an invitee. The meeting invitation includes a time period of the meeting, a meeting declination option, a meeting acceptance option, a partial meeting declination option, and a partial meeting acceptance option. A digital response is received from the invitee, wherein the response includes a partial meeting declination selection and/or a partial meeting acceptance selection. The partial meeting declination selection includes at least one time slot during the time period of the meeting that the invitee will not attend. The partial meeting acceptance selection includes at least one time slot during the time period of the meeting that the invitee will attend. In another embodiment, the response includes a meeting declination selection or a meeting acceptance selection.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method to indicate partial meeting request responses according to an embodiment of the invention;

FIG. 2 illustrates a slider on a graphical user interface according to an embodiment of the invention;

FIG. 3 illustrates an exemplary calendar entry according to an embodiment of the invention;

FIG. 4 is a flow diagram illustrating a method to indicate partial meeting request responses according to another embodiment of the invention; and

FIG. 5 illustrates a computer program product according to an embodiment of the invention.

### DETAILED DESCRIPTION

Example, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention provides a system and method that allows an individual to specify the time during a meeting request they will be able to attend. Thus, meeting moderators are able to properly update a meeting agenda with additional knowledge of attendance at any given time before and/or during a meeting. Moreover, attendees can accept a meeting while at the same time making it clear that they will not be attending the entire meeting. Time slots that are not accepted by the user remain free on the user's calendar for others to potentially schedule other meetings.

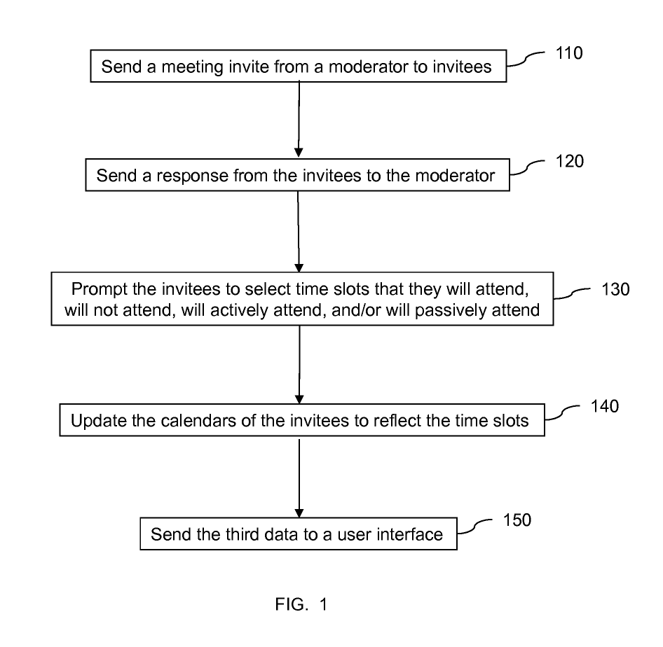

FIG. 1 is a flow diagram illustrating a method to indicate partial meeting request responses according to an embodiment of the invention. A meeting moderator sends a meeting invite to multiple invitees 110. The invitees send a response to the moderator 120, wherein the response includes at least one of: Accept, Decline, Delegate, Tentatively Accept, Tentatively Decline, Partially Decline, or Partially Accept.

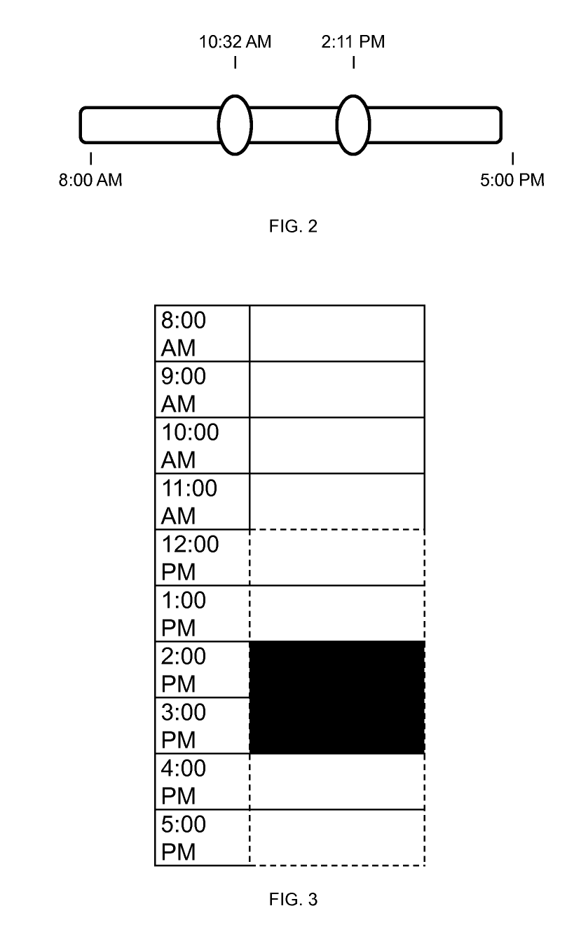

If the response is “Parial Decline” or “Partial Accept”, then a calendaring application will prompt the invitee to select the subset/times (also referred to herein as “time slots”) of the original meeting that the invitee will attend, will not attend, will actively attend, and/or will passively attend 130. In at least one embodiment, the invitee can select a response via text input. For example, if a meeting is from 11:00 AM to 12:00 PM, the invitee selects “will not attend” for the 11:00 AM-11:15 AM and 11:30 AM-12:00 PM time slots. In another embodiment, the invitee can select a response via a slider on a graphical user interface created with a programmed processor. For example, as illustrated in FIG. 2, for a meeting from 8:00 AM-5:00 PM, the invitee selects “will attend” for the 10:32 AM-2:11 PM time slot on the graphical user interface, which information is received by the processor.

In at least one embodiment of the invention, the response also includes a justification for one or more of the time slots. For example, the response includes a “will not attend” time slot and a justification “training seminar”. In another example, a meeting is for one hour, the invitee can make the first 15 minutes, then has to leave for the next 15 minutes, then is able to return to the meeting for the remaining half hour. In the invitee's response, a comment can be attached to each time slot: first time slot (15 minutes)=“I can be here but I'll be half listening as I will be preparing for my other call”; second time slot (15 minutes)=“I have to drop to go to another call”; and, third time slot (30 minutes)=“I will be able to join and will actively participate”.

The response is sent back to the moderator 140. In at least one embodiment, the invitee's calendar is updated to reflect the time slots that the user has responded “will attend” 150. The invitee's calendar will show that the invitee is free during those time slots that were not accepted as “will attend”. For example, FIG. 3 illustrates the invitee's calendar for the date of December 7th. The dotted box indicates that the meeting takes place from 12:00 PM-6:00 PM; and, the filled-in time slot indicates that the invitee has accepted to attend the 2:00 PM-4:00 PM portion of the meeting. When someone looks at the invitee's calendar they will see that the invitee is free before 2:00 PM and after 4:00 PM. Only the 2:00 PM-4:00 PM time slot appears unavailable for another meeting request. However, the invitee can visually see that the meeting has already started or is still occurring during those portions of the meeting the invitee has declined in case the invitee wants to join earlier than their accepted time slot.

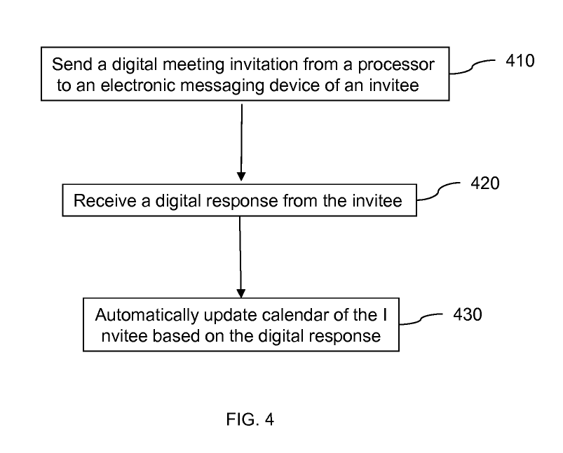

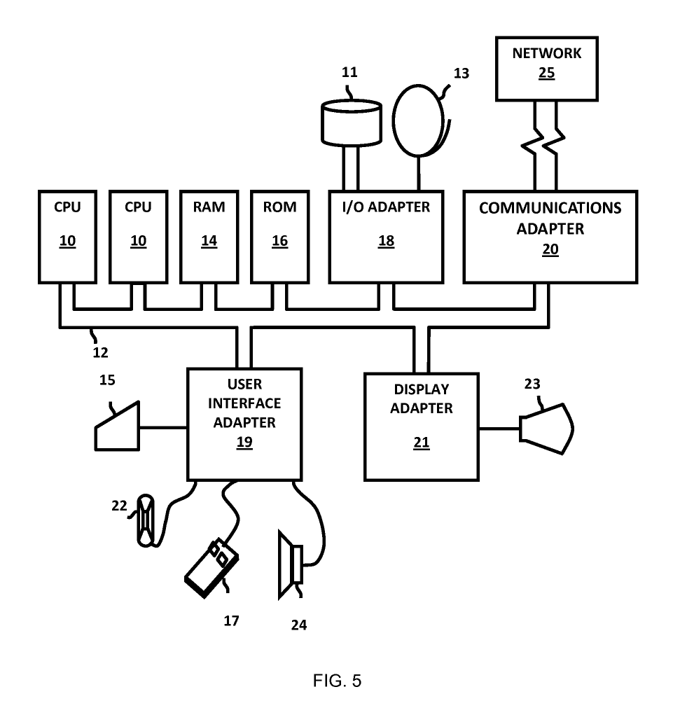

FIG. 4 is a flow diagram illustrating a method to indicate partial meeting request responses according to another embodiment of the invention. A digital meeting invitation is sent from a processor to an electronic messaging device (e.g., mobile telephone, computer tablet, or personal computer) of at least one invitee 410. As used herein, the term “meeting” includes in-person gatherings, web conferences, video conferences, and/or teleconferences for business or social events. In at least one embodiment, the meeting invitation includes: the time period of the meeting (e.g., 9:30 AM-12:00 PM), a meeting declination option, a meeting acceptance option, and a partial meeting acceptance option.

A digital response is received from the invitee 420 (e.g., by the processor). In at least one embodiment of the invention, the response includes a meeting declination selection, a meeting acceptance selection, a partial meeting declination selection, and/or a partial meeting acceptance selection. The partial meeting declination selection includes at least one time slot during the time period of the meeting that the invitee will not attend. The partial meeting acceptance selection includes at least one time slot during the time period of the meeting that the invitee will attend.

In at least one embodiment, the partial meeting acceptance selection further includes an active participation time slot, a passive participation time slot, and/or an unavailable time slot. For example, if an invitee is scheduled to attend a teleconference during the middle of an in-person meeting, the partial meeting acceptance selection may include a passive participation time slot time slot for which the attendee has to prepare for the teleconference, an unavailable time slot for attendance of the teleconference, and an active participation time slot time slot for attending the meeting after the teleconference has been completed.

In at least one embodiment of the invention, the electronic calendar of the invitee is automatically updated based on the digital response 430 sent (e.g., by the processor). In another embodiment, a graphical calendar is generated or updated, wherein the calendar includes invitee blocks that indicate digital responses received from invitees. The invitee blocks include at least one of the following: an identifier of the invitee, a photograph of the invitee, an available time slot, an unavailable time slot, a partially available time slot, an active participation time slot, and/or a passive participation time slot. The graphical calendar is displayed to a meeting moderator (e.g., by the processor), the invitee, and/or other invitees. In at least one embodiment, each invitee in the graphical calendar is represented as a bar or group of bars. Thus, for example, a meeting moderator can determine that invitees A and B will attend the meeting in its entirety, invitee C will attend the first hour, invitees D and E will not be able to attend, invitees F and G will attend the last two hours, and invitee H will attend the first hour and the last hour. In at least one embodiment, the graphical calendar is generated and displayed by the processor.

In at least one embodiment of the invention, an explanation is also received from the invitee (e.g., by the processor), wherein the explanation includes the reason why the digital response was selected. For example, an unavailable time slot selection could include the explanation “conference”, “education seminar”, “dentist appointment”, or “vacation”. In another example, a passive participation time slot could include the explanation “preparing for a presentation”, “not feeling well, working from home”, or “traveling”. In at least one embodiment, the processor sends the explanation to the meeting organizer and/or updates the calendar of the invitee to include the explanation.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of at least one programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 5, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method comprising:
sending a digital meeting invitation from a processor to an electronic messaging device of at least one invitee, the meeting invitation including:
a time period of the meeting,
a meeting declination option,
a meeting acceptance option,
a partial declination acceptance option, and
a partial meeting acceptance option; and
receiving a digital response by the processor from the at least one invitee, the response including:
a partial meeting declination selection, the partial meeting declination selection including at least one time slot during the time period of the meeting that the invitee will not attend, and
a partial meeting acceptance selection, the partial meeting acceptance selection including at least one time slot during the time period of the meeting that the invitee will attend, the partial meeting acceptance selection further including an active participation time slot and a passive participation time slot.

2. (canceled)

3. The method according to claim 1, further comprising automatically updating a calendar of the invitee with the processor, the calendar of the invitee being updated based on the digital response.

4. The method according to claim 1, further comprising:
generating a graphical calendar including invitee blocks, the invitee blocks indicating digital responses received from invitees; and
displaying the graphical calendar.

5. The method according to claim 4, wherein the invitee blocks include at least one of:
an identifier of the invitee,
an available time slot,
an unavailable time slot,
a partially available time slot,
an active participation time slot, and
a passive participation time slot.

6. The method according to claim 1, further comprising receiving an explanation from the invitee, the explanation including a reason why the digital response was selected.

7. The method according to claim 6, further comprising at least one of:
sending the explanation to a meeting organizer, and
updating a calendar of the invitee to include the explanation.

8. A method comprising:
sending a digital meeting invitation from a processor to an electronic messaging device of at least one invitee, the meeting invitation including:
a time period of the meeting,
a meeting declination option,
a meeting acceptance option, and
a partial meeting acceptance option;
receiving a digital response from the at least one invitee, the response including:
a meeting acceptance selection, and
a partial meeting acceptance selection, the partial meeting acceptance selection including at least one time slot during the time period of the meeting that the invitee will attend, the partial meeting acceptance selection further including an active participation time slot and a passive participation time slot, the passive participation time slot including an explanation for the passive participation;
prompting the at least one invitee to select the active participation time slot and the passive participation time slot in response to receiving the partial meeting acceptance selection; and
automatically updating a calendar of the invitee with the processor, the calendar of the invitee being updated based on the digital response.

9-10. (canceled)

11. The method according to claim 8, further comprising:
generating a graphical calendar including invitee blocks, the invitee blocks indicating digital responses received from invitees; and
displaying the graphical calendar to a meeting organizer.

12. The method according to claim 11, wherein the invitee blocks include at least one of:
an identifier of the invitee,
an available time slot,
an unavailable time slot,
a partially available time slot,
an active participation time slot, and
a passive participation time slot.

13. The method according to claim 8, further comprising receiving an explanation from the invitee, the explanation including a reason why the digital response was selected.

14. The method according to claim 13, further comprising at least one of:
sending the explanation to a meeting organizer, and
updating a calendar of the invitee to include the explanation.

15. A computer program product comprising:
a non-transitory computer readable storage medium;
first program instructions to send a digital meeting invitation from a processor to an electronic messaging device of at least one invitee, the meeting invitation including:
a time period of the meeting,
a meeting declination option,
a meeting acceptance option, and
a partial meeting acceptance option; and
second program instructions to receive a digital response from the invitee, the response including:
a meeting acceptance selection, and
a partial meeting acceptance selection, the partial meeting acceptance selection including at least one time slot during the time period of the meeting that the invitee will attend, the partial meeting acceptance selection further including an active participation time slot and a passive participation time slot,
said first and second program instructions are stored on said computer readable storage medium.

16. (canceled)

17. The computer program product according to claim 15, further comprising:
generating a graphical calendar including invitee blocks, the invitee blocks indicating digital responses received from invitees; and
displaying the graphical calendar to a meeting organizer.

18. The computer program product according to claim 17, wherein the invitee blocks include at least one of:
an identifier of the invitee,
an available time slot,
an unavailable time slot,
a partially available time slot,
an active participation time slot, and
a passive participation time slot.

19. The computer program product according to claim 15, further comprising receiving an explanation from the invitee, the explanation including a reason why the digital response was selected.

20. The computer program product according to claim 19, further comprising at least one of:
sending the explanation to a meeting organizer, and
updating a calendar of the invitee to include the explanation.

21. The method according to claim 1, further comprising prompting the at least one invitee to select at least one of the active participation time slot and the passive participation time slot in response to receiving the partial meeting acceptance selection.

22. The method according to claim 1, wherein the passive participation time slot includes an explanation for the passive participation.

23-24. (canceled)
